(19) United States
(12) Patent Application Publication
(10) Pub. No.: US 2025/0190753 A1
(43) Pub. Date: Jun. 12, 2025

(54) Method and Device for Improved Evaluation of Measurement Signals from a Sensor

(71) Applicant: Robert Bosch GmbH, Stuttgart (DE)

(72) Inventor: Achim Romer, Weinsberg (DE)

(21) Appl. No.: 18/973,365

(22) Filed: Dec. 9, 2024

(30) Foreign Application Priority Data
Dec. 11, 2023 (DE) 10 2023 212 482.3

(51) Int. Cl. G06N 3/044; G06N 3/045; G06N 3/09

(52) U.S. Cl. CPC G06N 3/044; G06N 3/045; G06N 3/09

(57) ABSTRACT

A method is for training a machine learning system for evaluating a measurement signal from a sensor that is configured to determine at least one variable characterizing an operating state of a technical system. The method includes determining a latent representation from the measurement signal using a first sub-system of the machine learning system. The method further includes determining the at least one variable characterizing the operating state of the technical system from the determined latent representation using a second sub-system of the machine learning system. The first sub-system is trained in an unsupervised or self-supervised manner, and the machine learning system is then trained in a supervised manner.

This application claims priority under 35 U.S.C. § 119 to patent application no. DE 10 2023 212 482.3, filed on Dec. 11, 2023 in Germany, the disclosure of which is incorporated herein by reference in its entirety.

The disclosure relates to a method for evaluating a measurement signal from a sensor, a computer program, a machine-readable storage medium and a control unit.

### BACKGROUND

According to the state of the art, a virtual sensor can be used to determine a target variable that depends on one or more correlating measured variables. In contrast to conventional physical sensors, the target variable is not measured directly, but is mapped by software based on correlations to other measured variables. Mathematical models, simulations or artificial intelligence can be used for this purpose.

For example, a method for evaluating a measurement signal from a sensor that is set up to determine at least one variable characterizing an operating state of a technical system is known from the non-prior-published DE 10 2023 206 032.9, wherein a low-frequency component of the measurement signal is determined and/or a high-frequency component of the measurement signal is determined, and wherein the evaluation of the low-frequency component and the evaluation of the high-frequency component is carried out using different evaluation methods to determine the variable characterizing the operating state of the technical system.

### SUMMARY

The disclosure has the advantage that it can achieve very good results with very little labeled data.

The dependent claims relate to beneficial further training.

In a first aspect, the disclosure therefore relates to a method for training a machine learning system for evaluating a measurement signal from a sensor that is set up to determine at least one variable characterizing an operating state of a technical system, wherein the machine learning system comprises a first sub-system that is set up to determine a latent representation and wherein the machine learning system comprises a second sub-system which is set up to determine the variable characterizing the operating state of the technical system from this latent representation, and wherein the first sub-system is trained in an unsupervised or self-supervised manner and wherein the machine learning system is then trained in a supervised manner.

“Latent representation” is the usual term used to describe a (typically vector-valued) compressed representation of the (also typically vector-valued) measurement signal.

This has the advantage that only a small amount of labeled data is required for training. This means that with a given amount of training data, the evaluation of the measurement signal works particularly well.

The machine learning system can be a neural network, for example.

It may be foreseen that during supervised training only the second sub-system is changed, i.e. that the first sub-system remains unchanged. This has the advantage that very little labeled data is required for training.

“Changing a sub-system” can mean in the usual way that parameters that characterize the behavior of this sub-system are changed.

Further training may provide for parts of the measurement signal to be used with weighting factors during unsupervised or self-supervised training of the first sub-system, wherein the weighting factors have been identified as particularly relevant for the correct determination of the variable characterizing the operating state of the technical system by means of a model that is set up to determine the variable characterizing the operating state of the technical system from the measurement signal.

In particular, in some embodiments it is possible for the weighting factors for sample instants of the time series to be determined from the model by means of a so-called “SHAP” method, and for a cost function characterizing this learning in the case of unsupervised or self-supervised learning to have a term in which contributions associated with the respective sample instants are weighted by these weighting factors.

This makes unsupervised or self-monitored training particularly efficient.

If the measurement signal is given as a time series, the parts of the measurement signal may in some embodiments be sections, in particular a contiguous section, of the measurement signal. In particular, it may be stipulated that a start time and an end time be specified for the time series in order to clearly characterize the part of the measurement signal.

The model can be a machine learning system, in particular a neural network, that has been trained using parallel pairs of measurement signals and variables characterizing the operating state of the technical system. Since the model is used only to identify the parts of the measurement signal that are most relevant for determining the training of the first sub-system, fewer pairs are required than for a completely correct reconstruction of the variable that characterizes the operating state of the technical system.

### BRIEF DESCRIPTION OF THE DRAWINGS

Embodiments of the disclosure are explained in greater detail below with reference to the accompanying drawings. In the drawings:

FIG. 1 Schematic representation of a sensor in a braking system.

FIG. 2 Schematic of a training device for a machine learning system.

FIG. 3 schematically shows an information flow through the machine learning system;

FIG. 4 Schematic representation of a process flow in a flow chart according to one embodiment of the disclosure.

### DETAILED DESCRIPTION

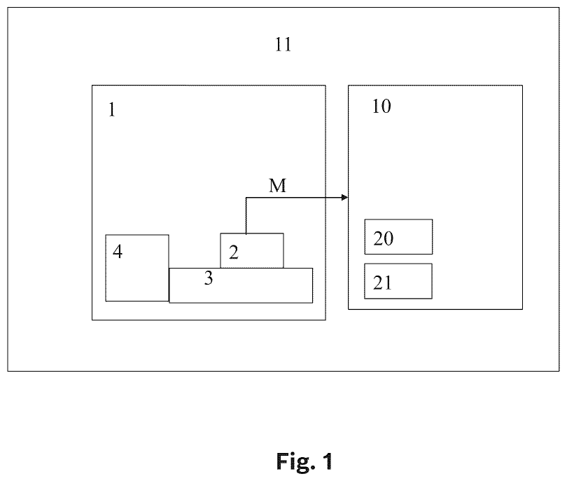

FIG. 1 schematically shows a braking system (1) of a motor vehicle (11) with, in the exemplary embodiment of a plurality of, comprising sensors (2) comprising a pressure sensor in a hydraulic supply line (3), with which a contact force of a brake caliper (4)), a sensor for determining a longitudinal acceleration of the motor vehicle (11), a sensor for detecting a temperature of the liquid in the hydraulic supply line (3) and a voltage sensor on a pump (not shown) for delivering the liquid. A multidimensional measurement signal (M) comprising the measurement signals of these sensors is supplied to a control unit (10) which comprises a computer-readable storage medium (20) on which a computer program is stored, on which a program for evaluating the measurement signal (M) is stored in order to determine a torque that the brake caliper (4) transmits to a wheel (not shown) of the motor vehicle (11). The control unit (10) also includes a processor (21) that is set up to execute the computer program stored on the storage medium (20).

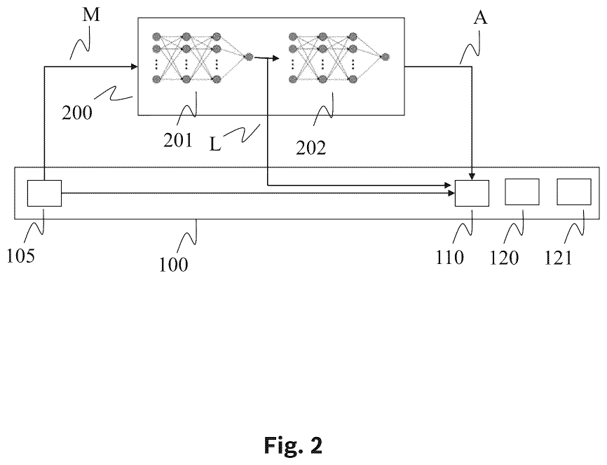

FIG. 2 schematically shows a training device (100) for training a machine learning system (200) which comprises a first sub-system (201) and a second sub-system (202). In the exemplary embodiment, the machine learning system is a neural network. The measuring device (100) includes a data memory (105) in which a plurality of measurement signals (M) are provided. The training device is set up to select measurement signals (M) and to supply them to the machine learning system (200).

The measurement signal (M) is fed to the first sub-system (201), which is set up to determine a latent representation (L) from it, i.e. a vector whose dimensionality is lower than the dimensionality of the measurement signal (M).

The machine learning system (200) is also set up to supply the determined latent representation (L) to the second sub-system (202), which determines an output variable (A) therefrom that characterizes an operating state of the technical system (11), in the exemplary embodiment an estimated torque transmitted by the brake caliper (4). In preferred embodiments, the variable characterizing the operating state of the technical system (11) is given by a time series.

The training device (100) is set up to transmit the latent variable (L) determined by the machine learning system (200) and the output variable (A) determined by the machine learning system (200) to an evaluating unit (110).

Furthermore, the training device (100) is set up to train the first sub-system (201). In some embodiments, the training device (100) is set up to provide an autoencoder for this purpose.

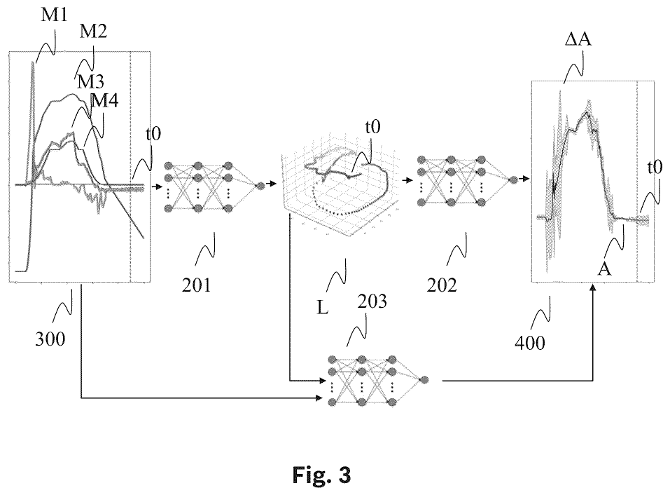

FIG. 3 schematically shows an information flow when operating the machine learning system (200). A provision unit (300) provides measurement variables (M1, . . . , M4) as time series of variables determined from sensor data, in the exemplary embodiment a torque determined from a current, a temperature, a voltage and a position of the brake caliper (4). At a given point in time (t0), these measured variables therefore correspond to a four-dimensional vector. These time series are fed to the first sub-system (201), which determines the latent representation (L) from them, in the illustrated example a three-dimensional vector at the respective time (t0). The time series of the measured variables (M1, . . . , M4) in the latent representation (L) correspondingly results in a progression in three-dimensional space. This latent representation (L) is fed to the second sub-system (202), which determines the output variable (A) from it. In the exemplary embodiment, the output variable (A) is one-dimensional, so at time (t0) it corresponds to a scalar value.

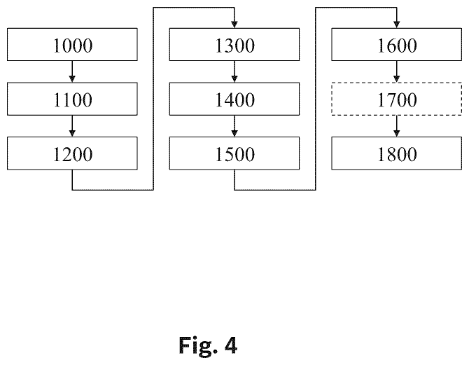

Measurement parameters (M1, . . . ,M4) and latent representation (L) are also supplied in some embodiments to a further machine learning system (203) that is trained to estimate an uncertainty of the output variable (DA) from these parameters. This further machine learning system (203) can be trained, for example, in the training method of the machine learning system (200) shown in FIG. 4, by determining the extent to which the machine learning system (200) is able to actually reconstruct the output variable (A) from the respective measurement signals (M) in such a way that it actually corresponds at the respective time (t0) to the provided measured or simulated value of the output variable (A). This degree of uncertainty can be used as a target in the supervised training of the machine learning system (203).

FIG. 4 shows an example of how the computer program runs in a flowchart. Initially (1000), a plurality of measurement signals (M) are received by the pressure sensor (2) and provided as time series data.

Subsequently, parallel variables (A) characterizing the operating state of the technical system (11), in the exemplary embodiment of the braking system (1), are provided for these respective time series (1100). These variables (A) characterizing the operating state of the technical system can, for example, be determined by simulation or, preferably, measured. In the exemplary embodiment, these variables characterizing the operating state (A) are again given as time series.

Now a recurrent neural network is trained (1200) using the pairs of measurement signals (M) and parallel variables (A) characterizing the operating state of the technical system (1) (in the exemplary embodiment, the recurrent neural network is trained 1200 times), from the measurement signals (M) which are provided to the recurrent neural network as input variables, to reconstruct the respective parallel variables (A) characterizing the operating state of the technical system (1) as output variables at an output of the recurrent neural network.

In this case, the recurrent NN is also trained to identify the most important parts of the time series for determining the operating data. In the exemplary embodiment, the SHAP method is used to assign a weighting factor to each sampling time in the time series. This method is described, for example, in A unified approach to interpreting model predictions. S. Lundberg, S. I. Lee, arXiv preprint arXiv:1705.07874, 2017.

A second set of measurement signals (M) is then provided (1300), which in some embodiments is larger than the set of measurement signals provided in step (1000).

The first sub-system (201) is trained (1400) with this second set of measurement signals (M) (in some embodiments unsupervised, in some embodiments self-supervised, for example with an autoencoder or by means of contrastive learning). For this purpose, the weighting factors identified for the measurement data (M) provided by means of the recurrent NN are provided and used as weighting for the respective measurement data (M) in order to train the first sub-system (201). In some exemplary embodiments, this training is carried out depending on a quadratic norm of a difference between a vector representing the measurement data (M) and a vector representing the measurement data reconstructed by the autoencoder, wherein each dimension of the vectors corresponds to a sample time and these quadratic distances of the individual sample times are weighted with the respective identified weighting factors to yield a cost function for the training.

Now a third set of measurement signals (M) is provided (1500), and in parallel to these measurement signals (M), analogously to step (1100), variables (A) characterizing the operating state of the technical system (11) are provided (1600). These variables (A) characterizing the operating state of the technical system can, for example, be determined by simulation or, preferably, measured. In the exemplary embodiment, these variables characterizing the operating state (A) are again given as time series.

Preferably, the most relevant parts are identified from these provided measurement signals (M) by means of the trained recurrent neural network and only these most relevant parts are provided for the subsequent training (1700).

The machine learning system (200) is now trained (1800) in a monitored fashion, using the measurement signals (M) provided in this way and the parallel variables (A) characterizing the operating state of the technical system (11), in order to reconstruct the variables (A) characterizing the operating state of the technical system (11) from the respective measurement signals (M). In the exemplary embodiment, this is done by adjusting only the parameters of the second sub-system (202).

The method hereby ends.

What is claimed is:

1. A method for training a machine learning system for evaluating a measurement signal from a sensor that is configured to determine at least one variable characterizing an operating state of a technical system, comprising:
determining a latent representation from the measurement signal using a first sub-system of the machine learning system; and
determining the at least one variable characterizing the operating state of the technical system from the determined latent representation using a second sub-system of the machine learning system,
wherein the first sub-system is trained in an unsupervised or self-supervised manner, and
wherein the machine learning system is then trained in a supervised manner.

2. The method according to claim 1, wherein only the second sub-system is changed during the training in the supervised manner.

3. The method according to claim 1, wherein:
during the unsupervised or self-supervised training of the first sub-system, parts of the measurement signal are weighted by weighting factors, and
the weighting factors are relevant for correctly determining a quantity characterizing the operating state of the technical system using a model configured to determine the quantity characterizing the operating state of the technical system from the measurement signal.

4. The method according to claim 3, wherein:
the model is a recurrent neural network, and
the model has been trained using parallel pairs of, in each case, the measurement signal and the variable characterizing the operating state of the technical system.

5. A measurement signal evaluator, comprising:
the machine learning system that has been trained in accordance with claim 1,
wherein the measurement signal evaluator is configured (i) to supply the measurement signal to the machine learning system, (ii) to determine the at least one variable characterizing the operating state of the technical system using the machine learning system, and (iii) to provide the determined at least one variable at an output of the measurement signal evaluator.

6. A training system configured to carry out the method according to claim 1.

7. A method for determining the at least one variable characterizing the operating state of the technical system as a function of the measurement signal, wherein the measurement signal is supplied to the measurement signal evaluator of claim 5, and the at least one variable characterizing the operating state of the technical system is provided by the measurement signal evaluator.

8. The method according to claim 1, wherein a computer program is configured to cause a computer to carry out the method when the computer program is executed on the computer.

9. A non-transitory machine-readable storage medium on which the computer program according to claim 8 is stored.

10. A computer configured to carry out the method according to claim 1.
